(19) United States
(12) Patent Application Publication
(10) Pub. No.: US 2017/0098212 A1
(43) Pub. Date: Apr. 6, 2017

(54) METHOD AND SYSTEM FOR IDENTIFICATION OF CREDENTIALS STORED IN A COMPUTING DEVICE

(71) Applicant: MasterCard International Incorporated, Purchase, NY (US)

(72) Inventors: Amyn DHALA, Jersey City, NJ (US); Axel Emile Jean Charles CATELAND, Scarsdale, NY (US); Nathaniel BYRD, Saint Peters, MO (US); Eric KITCHEN, O'Fallon, MO (US)

(73) Assignee: MASTERCARD INTERNATIONAL INCORPORATED, Purchase, NY (US)

(21) Appl. No.: 14/874,834

(22) Filed: Oct. 5, 2015

(51) Int. Cl. G06Q 20/36; G06Q 20/38; G06Q 20/10

(52) U.S. Cl. CPC G06Q 20/3674; G06Q 20/105; G06Q 20/3821

(57) ABSTRACT

A method for identifying payment credentials using a proxy electronic wallet comprises storing an account profile for a proxy electronic wallet that includes payment credentials for one or more payment accounts and account and/or payment credentials payment accounts associated with one or more paired electronic wallets. An account request is received from a digital entity that indicates the account profile, payment account identifiers are transmitted to a user computing device, a selection of a payment account is received from the user computing device, and a corresponding set of credentials in the account profile are identified. The credentials are then transmitted, where payment credentials are transmitted for use in a transaction, and account credentials are transmitted to an entity associated with the paired electronic wallet for use in identifying and providing corresponding payment credentials.

### FIELD

The present disclosure relates to identification of credentials stored in a computing device, specifically the identification of one of a plurality of sets of payment credentials stored in an electronic wallet serving as a proxy for one or more paired electronic wallets.

### BACKGROUND

As technology regarding computer security, in particular data storage security and data transmission security, improves, the trust individuals place in computing devices to handle sensitive data similarly improves. The use of computing devices to store and transmit data as an alternative to traditional, physical means can often result in faster, more efficient processes, which can provide additional convenience to a person's daily activities. In one such development, computing devices have been developed that can securely store and transmit payment credentials for a payment account, such as a credit card account, in what is known as an electronic wallet.

Electronic wallets can often serve as a digital replacement to a traditional wallet, with respect to payment instruments and payment methods a consumer may possess. Rather than present a physical payment card or check to a point of sale to make a purchase, a computing device with an electronic wallet application program installed can be used to store the associated payment credentials and transmit them to the point of sale at the time of a transaction, such as by using near field communication.

However, electronic wallets are often limited in operation. In many instances, electronic wallets are individual, self-contained applications that store payment credentials for a particular financial institution and/or payment type. As a result, it can often be difficult and time consuming for a person to set up a computing device to make available a plurality of different payment accounts for use in a transaction, and to select a particular payment account when making a payment. In addition, many financial institutions and other digital entities may have payment methods for an individual, but may lack the computing infrastructure and technology to support various types of electronic payments and transfers of payment credentials. Thus, it may be both difficult and, in some instances, impossible to utilize a computing device to convey payment credentials for a plurality of different accounts for use in transactions.

Thus, there is a need for a technical solution for an electronic wallet that can serve as a proxy for the identification of payment credentials for presentation in a payment transaction among a plurality of different electronic wallets and digital entity accounts. In such a solution, a user of a computing device could use a single application program and have payment credentials for various payment methods made available, without the use of additional application programs and even in instances where a specific payment method or payment type may be unavailable.

### SUMMARY

The present disclosure provides a description of systems and methods for identifying payment credentials using a proxy electronic wallet.

A method for identifying payment credentials using a proxy electronic wallet includes: storing, in an account database, a plurality of account profiles, wherein each account profile is related to a wallet account including at least a wallet identifier, authentication credentials, an account identifier associated with a digital entity paired to the related wallet account, where the digital entity is one of a plurality of digital entities, one or more payment identifiers, one or more first sets of payment credentials, where each set of the one or more first sets of payment credentials corresponds to a payment identifier of the one or more payment identifiers, one or more paired wallet identifiers, where each paired wallet identifier is related to an additional wallet account, and, for each of the one or more paired wallet identifiers, the wallet account further including one or more additional payment identifiers associated with the related wallet account, and one or more additional sets of credentials associated with the related additional wallet account, where each set of the one or more additional sets of credentials corresponds to an additional payment identifier of the one or more additional payment identifiers associated with the respective related additional wallet account; receiving, by a receiving device, an account request from a specific digital entity of the plurality of digital entities, wherein the account request includes at least a specific account identifier associated with the specific digital entity; identifying, by a processing device, a specific account profile stored in the account database where the included account identifier corresponds to the specific account identifier included in the received account request; transmitting, by a transmitting device, at least the one or more payment identifiers and the one or more additional payment identifiers corresponding to each of the one or more paired wallet identifiers; receiving, by the receiving device, a payment selection, wherein the payment selection includes a specific payment identifier selected from the transmitted one or more payment identifiers and one or more additional payment identifiers corresponding to each of the one or more paired wallet identifiers; identifying, by the processing device, a set of credentials associated with the specific payment identifier in the specific account profile, where the set of credentials is a first set of payment credentials of the one or more first sets of payment credentials if the specific payment identifier is selected from the one or more payment identifiers, and is an additional set of credentials of one of the one or more additional sets of credentials if the specific payment identifier is selected from the one or more additional payment identifiers corresponding to each of the one or more paired wallet identifiers; and transmitting, by the transmitting device, the identified set of credentials.

A system for identifying payment credentials using a proxy electronic wallet includes an account database, a receiving device, a processing device, and a transmitting device. The account database is configured to store a plurality of account profiles, wherein each account profile is related to a wallet account including at least: a wallet identifier; authentication credentials; an account identifier associated with a digital entity paired to the related wallet account, where the digital entity is one of a plurality of digital entities; one or more payment identifiers; one or more first sets of payment credentials, where each set of the one or more first sets of payment credentials corresponds to a payment identifier of the one or more payment identifiers; one or more paired wallet identifiers, where each paired wallet identifier is related to an additional wallet account, and, for each of the one or more paired wallet identifiers, the wallet account further including one or more additional payment identifiers associated with the related wallet account, and one or more additional sets of credentials associated with the related additional wallet account, where each set of the one or more additional sets of credentials corresponds to an additional payment identifier of the one or more additional payment identifiers associated with the respective related additional wallet account. The receiving device is configured to receive an account request from a specific digital entity of the plurality of digital entities, wherein the account request includes at least a specific account identifier associated with the specific digital entity. The processing device is configured to identify a specific account profile stored in the account database where the included account identifier corresponds to the specific account identifier included in the received account request. The transmitting device is configured to transmit at least the one or more payment identifiers and the one or more additional payment identifiers corresponding to each of the one or more paired wallet identifiers. The receiving device is further configured to receive a payment selection, wherein the payment selection includes a specific payment identifier selected from the transmitted one or more payment identifiers and one or more additional payment identifiers corresponding to each of the one or more paired wallet identifiers. The processing device is further configured to identify a set of credentials associated with the specific payment identifier in the specific account profile, where the set of credentials is a first set of payment credentials of the one or more first sets of payment credentials if the specific payment identifier is selected from the one or more payment identifiers, and is an additional set of credentials of one of the one or more additional sets of credentials if the specific payment identifier is selected from the one or more additional payment identifiers corresponding to each of the one or more paired wallet identifiers. The transmitting device is further configured to transmit the identified set of credentials.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the identification of payment credentials in a proxy electronic wallet in accordance with exemplary embodiments.

FIG. 2 is a block diagram illustrating the processing server of FIG. 1 for the identification of payment credentials in a proxy electronic wallet in accordance with exemplary embodiments.

FIG. 3 is a block diagram illustrating the account database of the processing server of FIG. 2 for the storage of payment credentials for use in a proxy electronic wallet in accordance with exemplary embodiments.

FIG. 4 is a flow diagram illustrating a process for the pairing of an electronic wallet to a proxy electronic wallet in accordance with exemplary embodiments.

FIG. 5 is a flow diagram illustrating a process for the identification and provisioning of payment credentials using a proxy electronic wallet using the processing server of FIG. 2 in accordance with exemplary embodiments.

FIG. 6 is a flow chart illustrating an exemplary method for identifying payment credentials using a proxy electronic wallet in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Payment Card—A card or data associated with a transaction account that may be provided to a merchant in order to fund a financial transaction via the associated transaction account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated transaction account (e.g., as stored in a communication device, such as a smart phone or computer). For example, in some instances, data including a payment account number may be considered a payment card for the processing of a transaction funded by the associated transaction account. In some instances, a check may be considered a payment card where applicable.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Identification of Payment Credentials Using a Proxy Electronic Wallet

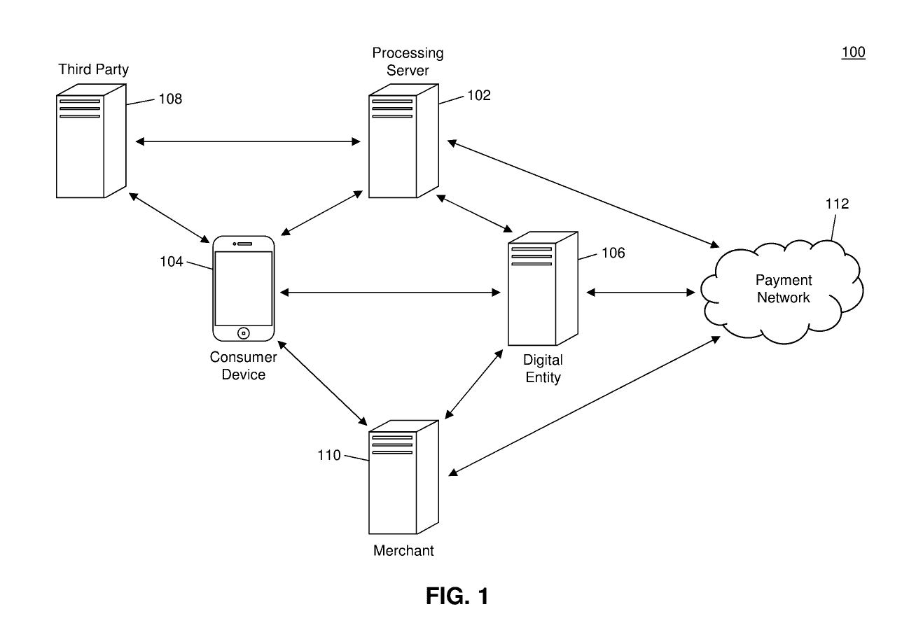

FIG. 1 illustrates a system 100 for the identification of payment credentials using a proxy electronic wallet for use in a payment transaction whereby transaction accounts associated with a plurality of digital entities may be used to fund the payment transaction via the proxy electronic wallet.

The system 100 may include a processing server 102. The processing server 102 may be configured to store payment credentials in conjunction with a proxy electronic wallet that is paired with one or more additional electronic wallets, as discussed herein. In the system 100, the proxy electronic wallet may be accessed by a user via a consumer device 104. The consumer device 104 may be any type of computing device suitable for performing the functions discussed herein, such as a desktop computer, laptop computer, notebook computer, laptop computer, cellular phone, smart phone, smart watch, wearable computing device, implantable computing device, smart television, etc.

The consumer device 104 may be configured to access an electronic wallet application program. The electronic wallet application program may be stored locally in one or more memories of the consumer device 104, or may be stored externally, such as at the processing server 102, and accessed remotely by the consumer device 104. For instance, the processing server 102 or other device may store the electronic wallet application program for execution by the consumer device 104 using cloud computing techniques. In some embodiments, the consumer device 104 may store program code for execution of the electronic wallet application program by the consumer device 104, but may utilize data stored in the processing server 102, such as payment credentials stored for one or more paired electronic wallets.

The consumer device 104 and processing server 102 may communicate using any suitable communication network and protocol. In one embodiment, the consumer device 104 may communicate with the processing server 102 via a cellular communication network, where data signals superimposed with data may be transmitted between the consumer device 104 and processing server 102 via network infrastructure operated by a mobile network operator. In another embodiment, the consumer device 104 may communicate with the processing server 102 via the Internet, which may utilize one or more internet service providers. In yet another embodiment, the consumer device 104 may communicate with a processing server 102 via a local area network, radio frequency, wireless area network, or other suitable method of communication. In such communications, electronic data signals superimposed with data may be transmitted between the consumer device 104 and processing server 102, to be parsed by the recipient computing device to obtain the data superimposed thereon.

The processing server 102 may store data associated with the electronic wallet application program of the consumer device 104 and the consumer device 104 itself, as discussed in more detail below. In the system 100, the processing server 102 may be configured to enable the user of the consumer device 104 to pair the electronic wallet of the consumer device 104 with one or more additional digital wallets and/or one or more accounts associated with one or more digital entities 106. Digital entities 106 may be entities with whom data may be exchanged via electronic transmissions that may store accounts and/or digital wallets for use by a consumer in the processing of a payment transaction. Digital entities 106 may include, for example, financial institutions, social networks, service providers, software providers, gaming platforms, media services, etc.

The consumer device 104 and digital entity 106 may be configured to exchange data via electronic transmission of data signals using methods discussed herein, such as the methods discussed above. Digital entities 106 may also be configured to exchange data via electronic transmission of data signals with the processing server 102 using such methods. Digital entities 106 may establish accounts, which may include electronic wallet accounts, with the consumer device 104 and/or a user of the consumer device 104. These accounts may be suitable for use in the funding of payment transactions involving the consumer device 104.

In some embodiments, the system 100 may also include one or more third parties 108. Third parties 108 may be configured to store data on behalf of the digital entity 106, processing server 102, or consumer device 104 for use in performing the functions of the system 100 as discussed herein. For example, a third party 108 may be configured to store payment credentials associated with a transaction account for use in funding a payment transaction, as discussed in more detail below. In another example, a third party 108 may be an electronic wallet provider, which may store data associated with an electronic wallet that is associated with a digital entity 106. In yet another example, the third party 108 may be configured to store program code for the proxy electronic wallet application program that is executed remotely by the consumer device 104, for accessing payment credentials stored by the processing server 102 for the proxy electronic wallet and for paired electronic wallets and accounts associated with digital entities 106.

In the system 100, a consumer may use the consumer device 104 in order to submit payment credentials for use in funding a payment transaction involving the consumer and a merchant 110. In some instances, the transaction may be an in-person transaction, such as where the consumer device 104 is physically in proximity of a point of sale device associated with the merchant 110, or may be a remote transaction, such as a payment transaction conducted via the Internet or other suitable communication network. In order to facilitate the submission of payment credentials to the merchant 110 for use in funding the payment transaction, the consumer may select payment credentials for use via the consumer device 104 using the proxy electronic wallet application program.

The consumer may execute the proxy electronic wallet application program using the consumer device 104. The proxy electronic wallet application program may present the consumer with a plurality of different payment accounts for use in funding the payment transaction. In some instances, the payment accounts may include payment accounts associated with the proxy electronic wallet application program directly, as well as additional payment accounts that may be associated with one or more digital entities 106 and/or one or more paired electronic wallets. The pairing of electronic wallets to the proxy electronic wallet for use in funding payment transactions is discussed in more detail below.

The payment accounts for selection may be displayed to the consumer via one or more suitable methods of display using the consumer device 104. The consumer may input a selection of a specific payment account using one or more input devices of the consumer device 104. The consumer device 104 may identify a payment identifier associated with the specific payment account indicated by the consumer and may be configured to generate a data signal superimposed with the payment identifier and electronically transmit the data signal to the processing server 102. In some embodiments, the data signal may also be superimposed with data identifying the consumer device 104, such as a device identifier, a wallet identifier associated with the proxy electronic wallet application program, etc. In some instances, the data signal may also include authentication credentials submitted by the consumer via the consumer device 104, such as a personal identification number, password, biometric data, etc.

The processing server 102 may parse the data signal to obtain the payment identifier and any additional data superimposed thereon, such as the wallet identifier and authentication credentials. The processing server 102 may then identify an account profile associated with the proxy electronic wallet application program executed by the consumer device 104. The account profile, discussed in more detail below, may be identified via execution of a query by a querying module or engine of the processing server 102 on a database configured to store account profiles, which may identify the account profile using the wallet identifier. The processing server 102 may then identify the payment account to be used to fund the payment transaction via the payment identifier parsed from the data signal transmitted to the processing server 102 by the consumer device 104. Payment credentials may then be identified by the processing server 102 for use in funding the payment transaction.

In one embodiment, the processing server 102 may be configured to store payment credentials directly. In some instances, the processing server 102 may store payment credentials for payment accounts directly associated with the proxy electronic wallet application program, while payment credentials associated with paired electronic wallets or digital entities 106 may be stored externally to the processing server 102, such as by the third party 108 or respective digital entities 106. In other embodiments, the processing server 102 may not store payment credentials directly. In such embodiments, all payment credentials may be stored by third parties 108 and/or digital entities 106.

The storage of payment credentials may utilize methods and systems for the secured storage of payment credentials that will be apparent to persons having skill in the relevant art. Payment credentials may include any data suitable for use in the identification, verification, validation, and authentication of a payment account to be used to fund a payment transaction, which may include a primary account number, one or more cryptograms, authentication credentials, and other data. In some instances, payment credentials may be stored in a Secure Element or other suitable type of secure storage, as will be apparent to persons having skill in the relevant art. In some embodiments, payment credentials may be encrypted prior to use, and may be decrypted by the processing server 102, third party 108, or digital entity 106 prior to transmission, or may be transmitted while still encrypted and decrypted by a receiving entity, such as a payment network 112, discussed below.

Once the payment account has been identified by the processing server 102, the processing server 102 may initiate the submission of payment credentials for payment of the payment transaction. In instances where the processing server 102 may store the payment credentials directly for the selected payment account, the processing server 102 may perform any methods necessary for processing of the payment credentials (e.g., generation of cryptograms, etc.) and may generate a data signal superimposed with the payment credentials and any associated data. The data signal may be electronically submitted to the merchant 110 involved in the payment transaction, for processing using traditional methods and systems. In some embodiments, the processing server 102 may electronically transmit the data signal superimposed with the payment credentials directly to a payment network 112.

The payment network 112 may be configured to process payment transactions using traditional systems and methods that will be apparent to persons having skill in the relevant art. In some embodiments, payment credentials submitted directly to the payment network 112 may be submitted using the payment rails. The payment rails may be specially configured infrastructure associated with a payment network 112 that uses specialized protocols and specially formatted data signals, such as transaction messages formatted based on one or more standards (e.g., the International Organization of Standardization's ISO 8583 standard), for the secure transmission of financial data. Payment rails may be a specialized communication network that a general purpose computing device is unable to physically access the payment rails, format data suitable for transmission using the payment rails, and/or parse data that is transmitted using the payment rails.

In instances where the processing server 102 may not store the payment credentials for the selected payment account directly, the processing server 102 may be configured to generate a data signal superimposed with data indicating the selected payment account, such as the payment identifier, and transmit it to an entity associated with the selected payment account that stores the corresponding payment credentials, such as the digital entity 106 or third party 108. In such instances, the data signal may be further superimposed with authentication credentials used for validation and authentication, such as to ensure that the request for payment credentials is genuine and authorized by a user associated with the selected payment account. In some embodiments, the authentication credentials may be supplied by the consumer of the consumer device 104 upon selection of the payment account.

In some instances, account credentials may also be superimposed in the data signal electronically transmitted to the digital entity 106 or third party 108. Account credentials may be associated with the consumer account or paired electronic wallet to which the selected payment account is associated. Account credentials may differ from authentication credentials in that account credentials may be used to access and manage the associated account and/or digital wallet, such as a username and password, while authentication credentials may be required when conducting a payment transaction, such as a personal identification number. In some embodiments, a digital entity 106 or third party 108 may not require account credentials to be submitted during a payment transaction. In some instances, the consumer may submit the account credentials to the processing server 102 during selection of the payment account to be used to fund the payment transaction. In other instances, the processing server 102 may store the account credentials (e.g., in the account profile) and may include them in the data signal electronically transmitted to the digital entity 106 or third party 108. In such embodiments, the consumer may thereby be able to select any payment account, including those not directly associated with the processing server 102, without repeatedly entering account credentials.

When the digital entity 106 or third party 108 receives the data signal, the entity may parse the data signal to obtain the data superimposed thereon, which may the payment identifier and any other suitable data, such as account and authentication credentials. The entity may use suitable methods for authentication using the account and authentication data, and, if the request is authenticated, by identify payment credentials associated with the selected payment account (e.g., using the payment identifier). The payment credentials may then be submitted to the merchant 110, directly to the payment network 112, or returned to the processing server 102, where the processing server 102 may submit the payment credentials to the merchant 110 or payment network 112.

Methods and systems discussed herein may enable a user of a consumer device 104 to access payment credentials associated with a plurality of different digital entities and electronic wallets via a single proxy electronic wallet, via use of the processing server 102. The processing server 102 may securely store data associated with the proxy electronic wallet and directly associated payment accounts, as well as data associated with paired electronic wallets and digital entity accounts and may use electronic communications in such a way that a user may be able to select payment credentials for various payment accounts without the use of multiple application programs that may utilize different methods of authentication, have different interfaces, different limitations, and may be difficult for use by the user having to remember the various interfaces, authentication methods, and associated credentials the use may need to supply. As a result, the processing server 102 and system 100 discussed herein may enable the identification of payment credentials for use in a payment transaction more efficiently than in traditional systems.

### Processing Server

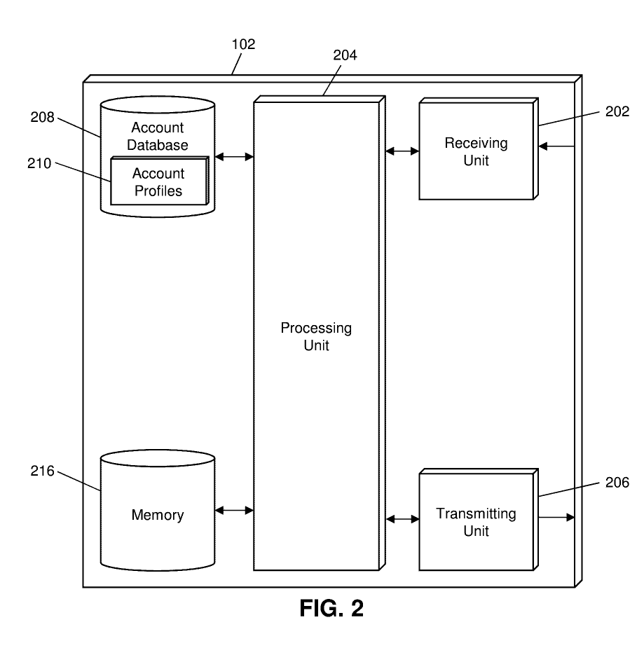

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving unit 202. The receiving unit 202 may be configured to receive data over one or more networks via one or more network protocols. In some embodiments, the receiving unit 202 may be configured to receive data over the payment rails, such as using specially configured infrastructure associated with payment networks 112 for the transmission of transaction messages that include sensitive financial data and information. In some instances, the receiving unit 202 may also be configured to receive data from consumer devices 104, digital entities 106, third parties 108, and other entities via alternative networks, such as the Internet. In some embodiments, the receiving unit 202 may be comprised of multiple units, such as different receiving units for receiving data over different networks, such as a first receiving unit for receiving data over payment rails and a second receiving unit for receiving data over the Internet. The receiving unit 202 may receive electronically data signals that are transmitted, where data may be superimposed on the data signal and decoded, parsed, read, or otherwise obtained via receipt of the data signal by the receiving unit 202. In some instances, the receiving unit 202 may include a parsing module for parsing the received data signal to obtain the data superimposed thereon.

The receiving unit 202 may be configured to receive data signals from the consumer device 104 superimposed with data selecting a payment account for use in funding a payment transaction. The receiving unit 202 may parse the received data signal to obtain data superimposed thereon, which may include a payment identifier, a wallet identifier, and any account or authentication credentials that may be used in the identification of payment credentials associated with the selected payment account. The receiving unit 202 may also be configured to receive payment credentials, such as from the digital entity 106 or third party 108. Payment credentials may be superimposed on a data signal that and may be encrypted, or the data signal itself may be encrypted. In such instances, the receiving unit 202 or other unit of the processing server 102 may include a decrypting module or engine configured to decrypt the data signal or the data superimposed thereon.

The processing server 102 may also include a processing unit 204. The processing unit 204 may be configured to perform the functions of the processing server 102 discussed herein as will be apparent to persons having skill in the relevant art. In some embodiments, the processing unit 204 may include and/or be comprised of a plurality of engines and/or modules specially configured to perform one or more functions of the processing unit 204. For example, the processing unit 204 may include a querying module configured to query databases included in the processing server 102 to identify information stored therein. In some instances, the processing unit 204 may include a parsing module or engine configured to parse data from data signals electronically received by the receiving unit 202, an encryption module or engine configured to decrypt received data or data signals or to encrypt data or data signals received or transmitted by the processing server 102, and any other modules suitable for performing the functions discussed herein.

The processing server 102 may also include an account database 208. The account database 208 may be configured to store a plurality of account profiles 210 using an appropriate data storage format and schema. The account profiles 210, discussed in more detail below, may be configured to store data associated with a consumer device 104, the proxy electronic wallet application program, one or more digital entities 106, and one or more paired electronic wallets. In some instances, account profiles 210 may be configured to store account credentials, authentication credentials, and payment credentials that may be used in the funding of a payment transaction.

The processing unit 204 may be configured to execute queries on the account database 208 to identify data stored therein. For instance, the processing unit 204 may be configured to identify an account profile 210 associated with a consumer device 104 and/or proxy electronic wallet application program once a selection of a payment account has been made using the respective consumer device 104 or proxy electronic wallet application program. In such an instance, a wallet identifier and payment identifier may be parsed from a data signal transmitted by the consumer device 104, and the processing unit 204 may execute a query on the account database 208 to identify an account profile 210 that includes the wallet identifier. The processing unit 204 may then identify payment credentials stored in the identified account profile 210 that are associated with the payment identifier.

The processing server 102 may further include a transmitting unit 206. The transmitting unit 206 may be configured to transmit data over one or more networks via one or more network protocols. In some embodiments, the transmitting unit 206 may be configured to transmit data over the payment rails, such as using specially configured infrastructure associated with payment networks 112 for the transmission of transaction messages that include sensitive financial data and information, such as identified payment credentials. In some instances, the transmitting unit 206 may be configured to transmit data to consumer devices 104, digital entities 106, third parties 108, merchants 110, and other entities via alternative networks, such as the Internet. In some embodiments, the transmitting unit 206 may be comprised of multiple units, such as different transmitting units for transmitting data over different networks, such as a first transmitting unit for transmitting data over the payment rails and a second transmitting unit for transmitting data over the Internet. The transmitting unit 206 may electronically transmit data signals that have data superimposed that may be parsed by a receiving computing device. In some instances, the transmitting unit 206 may include one or more modules for superimposing, encoding, or otherwise formatting data into data signals suitable for transmission.

The transmitting unit 206 may be configured to transmit payment credentials to merchants 110 or payment networks 112 for use in funding payment transactions. Payment credentials may be superimposed on data signals electronically transmitted by the transmitting unit 206 to the appropriate entity. In some instances, the transmitting unit 206 may include an encryption module or engine for encrypting the payment credentials and/or data signal prior to transmission. In some instances, the transmitting unit 206 may electronically transmit data signals to the digital entity 106 or third party 108 to request payment credentials for submission, or to provide instructions for the submission of payment credentials for a payment transaction. Such data signals may be superimposed with the payment identifier, and, if necessary, account and/or authentication credentials. The transmitting unit 206 may also be configured to transmit data signals superimposed with account credentials to digital entities 106 and third parties 108 for use in pairing the proxy electronic wallet with additional electronic wallets and digital entity accounts, as discussed in more detail below.

The processing server 102 may also include a memory 216. The memory 216 may be configured to store data for use by the processing server 102 in performing the functions discussed herein. The memory 216 may be configured to store data using suitable data formatting methods and schema and may be any suitable type of memory, such as read-only memory, random access memory, etc. The memory 216 may include, for example, encryption keys and algorithms, communication protocols and standards, data formatting standards and protocols, program code for the proxy electronic wallet application program and other programs, and other data that may be suitable for use by the processing server 102 in the performance of the functions disclosed herein as will be apparent to persons having skill in the relevant art.

### Account Database

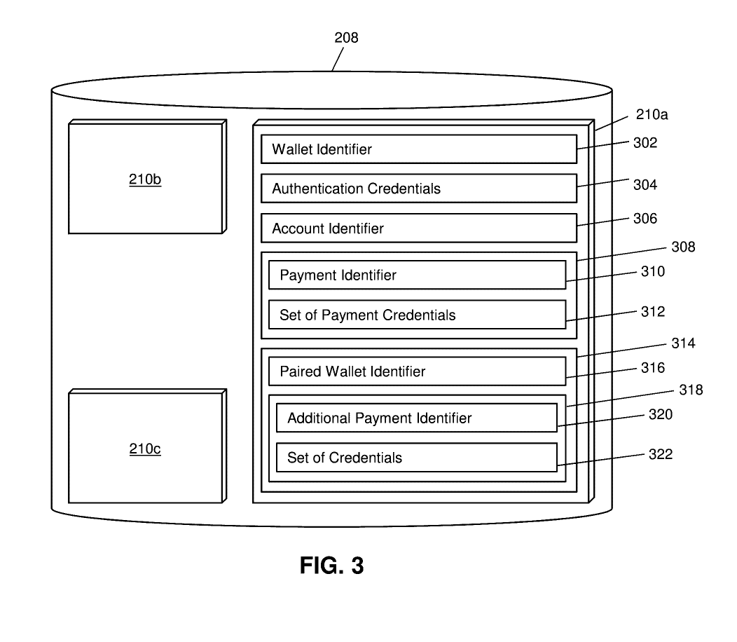

FIG. 3 illustrates the account database 208 of the processing server 102 for the storage of account profiles 210 associated with a proxy electronic wallet for use in identifying payment credentials for use in a payment transaction.

The account database 208 may be configured to store a plurality of account profiles 210, illustrated in FIG. 3 as account profiles 210a, 210b, and 210c. Each account profile 210 may include a standardized data set may be store data based on one or more data storage formats and schema. As illustrated in FIG. 3, each account profile 210 may include a wallet identifier 302, authentication credentials 304, one or more account identifiers 306, one or more sets of payment account data 308, and one or more sets of paired wallet data 314.

The wallet identifier 302 may be a unique value associated with the proxy electronic wallet suitable for use in the identification of the proxy electronic wallet and/or respective account profile 210. The wallet identifier 302 may be, for example, an identification number, registration number, serial number, username, e-mail address, phone number, etc. In some instances, the wallet identifier 302 may be a device identifier associated with a consumer device 104, such as a media access control address, serial number, etc.

The authentication credentials 304 may be credentials used for authenticating a request for use of payment credentials, which may authenticate the request as coming from an authorized consumer device 104 and/or an authorized user. The authentication credentials 304 may include, for example, a personal identification number, password, biometric data, a combination thereof, or any other data that may be suitable for use in authentication. For instance, the authentication credentials 304 may include a personal identification number to authenticate a user, as well as a device fingerprint to authenticate the consumer device 104 as an authorized device.

Each account identifier 306 may be a unique value associated with a digital entity 106 with whom the user of the consumer device 104 and/or the consumer device 104 has an account. The account identifier 306 may be, for example, an identification number, registration number, username, e-mail address, phone number, etc. In some instances, each account identifier 306 included in an account profile 210 may be formatted differently, such as based on formatting rules set forth by the associated digital entity 106.

Each set of payment account data 308 may be associated with a payment account associated with the proxy electronic wallet for use in funding payment transactions and include at least a payment identifier 310 and a set of payment credentials 312. The payment identifier 310 may be a value unique to the sets of payment account data 308 suitable for use in identifying a payment account selected by the user of the consumer device 104, such as an identification number, name, image, or other suitable value. For example, each payment identifier 310 may be a nickname for the associated payment account as provided by the user of the consumer device 104 for selection of the respective payment account. The set of payment credentials 312, as discussed above, may include a primary account number, application cryptograms, and any other data necessary for the processing of a payment transaction to be funded by the payment account associated with the payment credentials. In some embodiments, the set of payment credentials 312 may be stored in a secure storage (e.g., a Secure Element) separate from the rest of the account profile 210. In such embodiments, the set of payment credentials 312 may be identified via the associated payment identifier 310.

Each set of paired wallet data 314 may be associated with an electronic wallet paired to the proxy electronic wallet. Each paired electronic wallet may be associated with a digital entity 106 or third party 108 and may include payment credentials for one or more payment accounts associated with the respective electronic wallet. Each set of paired wallet data 314 may include a paired wallet identifier 316. The paired wallet identifier may be a unique value associated with the paired electronic wallet, such as for use in the identification thereof by the associated digital entity 106, third party 108, etc. Each set of paired wallet data 314 may also include one or more sets of additional payment account data 318, each associated with a payment account associated with the paired electronic wallet. Each of the sets of additional payment account data may 318 may include at least an additional payment identifier 320 and at least one set of credentials 322. The additional payment identifier 320 may be a value similar to the payment identifiers 310, suitable for use in identifying the respective associated payment account. The set of credentials 322 may be payment credentials, account credentials, or authentication credentials. Payment credentials may be the payment credentials suitable for use in processing a payment transaction funded using the associated payment account. The account credentials may be credentials suitable for use in authentication by the paired electronic wallet, such as to authenticate the processing server 102, consumer device 104, or user thereof as being authorized to use the associated payment account. In some embodiments, a single set of account credentials may be associated with each set of additional payment account data 318 for a set of paired wallet data 310. The authentication credentials may be used for authentication for usage of the associated payment account, such as a personal identification number, password, etc.

### Process for Pairing Electronic Wallets to a Proxy Electronic Wallet

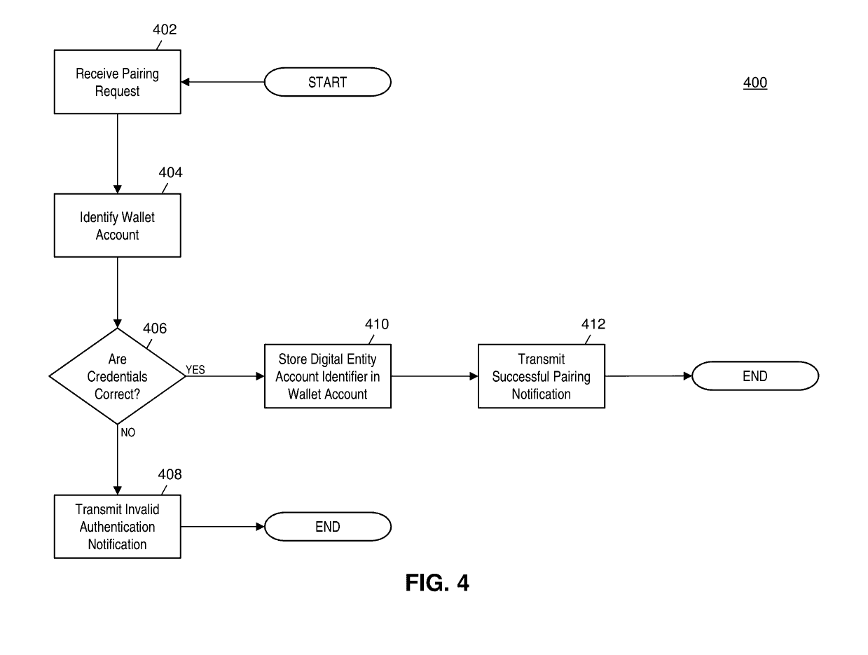

FIG. 4 illustrates a process 400 for the pairing of an electronic wallet associated with a digital entity 106 or third party 108 to the proxy electronic wallet provided by the processing server 102 in the system 100.

In step 402, the receiving unit 202 of the processing server 102 may receive a data signal electronically transmitted by the consumer device 104 that is superimposed with data comprising a pairing request. The pairing request may include at least a specific wallet identifier associated with the consumer device 104 or proxy electronic wallet application program, a set of account credentials, a paired wallet identifier 316, and information identifying a digital entity 106 or third party 108 associated with the electronic wallet to be paired. The receiving unit 202 or processing unit 204 of the processing server 102 may include a parsing module that may parse the pairing request and data included therein from the received data signal.

In step 404, the processing unit 204 (e.g., a querying module included therein) of the processing server 102 may be configured to execute a query on the account database 208 to identify an account profile 210 associated with the request where the wallet identifier 302 included in the account profile 210 corresponds to the specific wallet identifier included in the pairing request. In some embodiments, the pairing request may further include authentication credentials provided by the user of the consumer device 104 prior to submission of the pairing request. In such an embodiment, the processing unit 204 (e.g., an authentication module included therein) may authenticate the pairing request by comparing the supplied authentication credentials to the authentication credentials 304 included in the identified account profile 210. If the authentication fails, the user and/or consumer device 104 may not be authorized to pair the proxy electronic wallet and the process 400 may be stopped, and a notification transmitted (e.g., by the transmitting unit 206 of the processing server 102) to the computing device 104 indicating accordingly.

In step 406, the processing unit 204 may determine if the account credentials supplied in the pairing request are correct. In some embodiments, the processing server 102 may possess account credentials for a plurality of electronic wallets associated with various digital entities 106 and/or third parties 108, such as supplied by the respective entities for pairing. In such an embodiment, the processing unit 204 may identify (e.g., via the querying of a database configured to store the credentials) the stored account credentials using the paired wallet identifier 316 supplied in the pairing request and may compare the sets of credentials to determine if the credentials supplied in the pairing request were correct. In other embodiments, the transmitting unit 206 of the processing server 102 may electronically transmit a data signal superimposed with the paired wallet identifier and account credentials from the pairing request to the digital entity 106 or third party 108 indicated therein, and the receiving unit 202 may receive a data signal in response superimposed with data that, when parsed, may indicate if the correct account credentials were supplied.

If, in step 406, the account credentials provided by the user of the consumer device 104 were incorrect, then, in step 408, the transmitting unit 206 may electronically transmit a data signal to the consumer device 104 that is superimposed with data notifying the user that the authentication information (e.g., the account credentials) provided by the user to authenticate the user as authorized to pair the specified electronic wallet was invalid. The process 400 may then be completed, and may be re-attempted by the user of the consumer device 104, such as using different account credentials or to pair a different electronic wallet.

If, in step 406, the account credentials provided by the user of the consumer device 104 are correct, then, in step 410, the processing unit 204 may store a new set of paired wallet data 314 in the identified account profile 210 corresponding to the paired electronic wallet. The new set of paired wallet data 314 may include the paired wallet identifier 316 included in the pairing request and the account credentials included in the pairing request. In some instances, the digital entity 106 or third party 108 may provide sets of payment credentials for payment accounts associated with the paired electronic wallet for storage in the set of paired wallet data 314 in respective sets of additional payment account data 318. In some embodiments, the digital entity 106 or third party 108 may provide the data upon authentication of the credentials provided in the pairing request (e.g., during step 406). In other embodiments, the processing server 102 may separately request the data after pairing of the electronic wallet. In yet other embodiments, the user associated with the account profile 210 may request pairing of payment accounts associated with the paired electronic wallet specifically, which may be included in the set of paired wallet data 314 using similar methods where authentication credentials may be used in place of account credentials.

In step 412, the transmitting unit 206 of the processing server 102 may transmit a data signal superimposed with data notifying the user of the consumer device 104 that the pairing of the electronic wallet to the proxy electronic wallet was successful. The user may then use any payment accounts associated with the paired electronic wallet, via the proxy electronic wallet application program, to fund a payment transaction using the consumer device 104.

### Process for Identifying Payment Credentials Using a Proxy Electronic Wallet

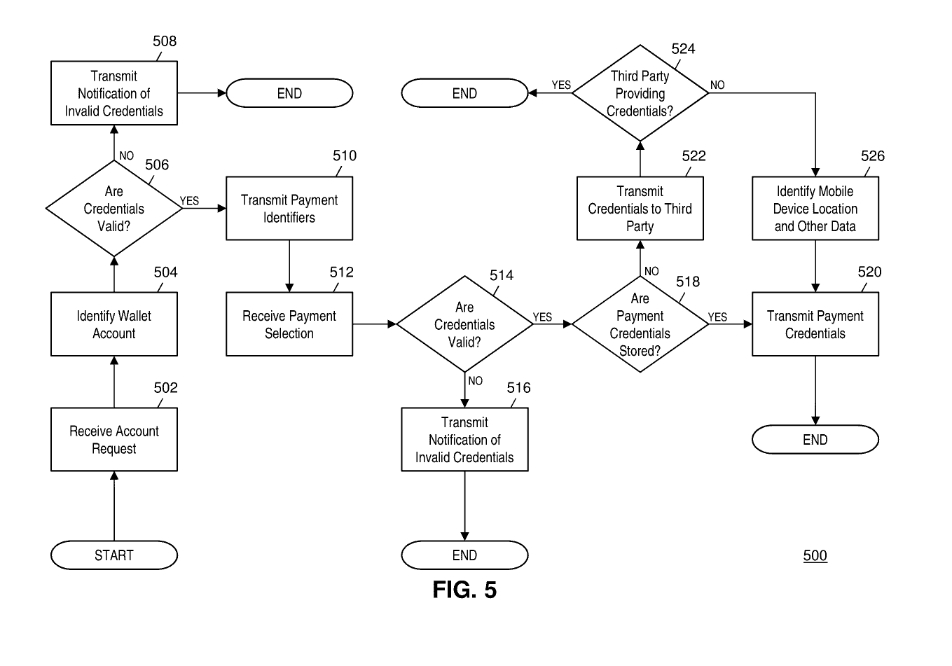

FIG. 5 illustrates a process 500 for the identification of payment credentials using a proxy electronic wallet, where the payment credentials may be associated with the proxy electronic wallet, a paired electronic wallet, or a digital entity and may be identified by the processing server 102 or external entity for use in the funding of a payment transaction.

In step 502, the receiving unit 202 of the processing server 102 may receive a data signal from the consumer device 104 via a suitable communication network, the data signal being superimposed with data comprising an account request. The account request may be a request to utilize a payment account to fund a payment transaction and may include at least a wallet identifier associated with the proxy electronic wallet being used and authentication credentials associated with the proxy electronic wallet. The receiving unit 202 of the processing unit 204 of the processing server 102 may parse, via a parsing module or engine, the received data signal to obtain the account request superimposed thereon.

In step 504, the processing unit 204 of the processing server 102 may execute a query on the account database 208 to identify an account profile 210 stored therein where the wallet identifier 302 included in the account profile 210 corresponds to the wallet identifier included in the account request. In step 506, the processing unit 204 (e.g., an authentication module thereof) may determine if the authentication credentials supplied in the account request are valid. The determination may be based on a comparison of the supplied authentication credentials to the authentication credentials 304 stored in the identified account profile 210 associated with the proxy electronic wallet. If, in step 506, the supplied authentication credentials are invalid, then, in step 508, the transmitting unit 206 of the processing server 102 may electronically transmit a data signal to the consumer device 104 superimposed with data notifying the user that the supplied authentication credentials were invalid.

If, in step 506, the supplied authentication credentials are valid, then, in step 510, the transmitting unit 206 may electronically transmit a data signal to the consumer device 104 superimposed with payment identifiers 310 and additional payment identifiers 320 for the sets of payment account data 308 and sets of additional payment account data 318 included in the identified account profile 210. In some embodiments, the identifiers may be stored locally on the consumer device 104. In such embodiments, step 510 may include the transmission of an instruction to the consumer device 104 to instruct the proxy electronic wallet application program that selection of payment identifiers may proceed as authentication was successful.

The user may then select a payment account to be used to fund the payment transaction via the consumer device 104, and, in step 512, the receiving unit 202 of the processing server 102 may receive a data signal superimposed with data comprising the payment selection made by the user. The payment selection may include at least the payment identifier 310 or additional payment identifier 320 associated with the selected payment account and authentication credentials associated with the selected payment account. In some instances, the payment selection may also include the wallet identifier 302 or other value used to identify the transaction occurring between the processing server 102 and consumer device 104, such as a session identifier. The use of session identifiers and other methods for tracking communications associated with a single transaction will be apparent to persons having skill in the relevant art.

In step 514, the authentication module of the processing unit 204 may determine if the authentication credentials provided by the user for the selected payment account are valid. The determination may be based on a comparison of the authentication credentials supplied in the payment selection to the set of payment credentials 312 or set of credentials 322 associated with the payment identifier 310 or additional payment identifier 320, respectively, included in the payment selection. If, in step 514, the authentication credentials are determined to be invalid, then, in step 516, the transmitting unit 206 may electronically transmit a data signal to the consumer device 104 superimposed with data notifying the user that the authentication credentials were invalid.

If, in step 514, the authentication credentials are valid, then, in step 518, the processing unit 204 may determine, via an analytical module or engine, if the account profile 210 includes a set of payment credentials (e.g., set of payment credentials 312 or set of credentials 322) for the selected payment account associated with the payment identifier 310 or additional payment identifier 320 included in the payment selection. If payment credentials are stored in the account profile 210 for the selected payment account, then, in step 520, the transmitting unit 206 may electronically transmit a data signal superimposed with the payment credentials to the consumer device 104, the merchant 110 involved in the payment transaction, or directly to the payment network 112 used to process the transaction. In some instances, additional functions may be performed by the processing unit 204 prior to transmission of the payment credentials, such as the generation of cryptograms to be included in the credentials.

If the account profile 210 does not include payment credentials for the selected payment account, then, in step 522, the transmitting unit 206 may electronically transmit a data signal to the third party (e.g., digital entity 106, third party 108, or other entity) associated with the selected payment account that is superimposed with at least the additional payment identifier 320 and a set of account credentials 322 associated with the selected payment account. In some embodiments, the data signal may also be superimposed with authentication credentials, such as those supplied by the consumer device 104 in the payment selection in step 512.

In step 524, the processing unit 204 may determine if the third party associated with the selected payment account is to provide the payment credentials for use in the payment transaction or if the payment credentials are to be provided by the processing server 102. The determination may be made based off of data stored in the processing server 102, such as in the memory 216, such as settings associated with the third party with whom the selected payment account is associated. For instance, some third parties may prefer to provide payment credentials themselves, whereas other third parties may provide payment credentials to the processing server 102 for submission to the consumer device 104, merchant 110, or payment network 112. In such instances, a third party may be able to provide an electronic wallet, but without having to communicate directly to consumer devices 104.

If the processing unit 204 determines that the third party is providing the payment credentials, then the process 500 may be completed. If the processing unit 204 determines that the third party is not providing the payment credentials directly to the consumer device 104, merchant 110, or payment network 112 for use in the payment transaction, then, in step 526, the payment credentials may be received by the receiving device 202 from the third party as superimposed on a data signal electronically transmitted by the third party and the processing unit 204 may identify any other data that may be used in the processing of the payment transaction. For example, the processing unit 204 may identify a geographic location of the consumer device 104 in instances where the consumer device 104 is a mobile computing device and the payment transaction is an in-person transaction. The process 500 may then proceed to step 520, where the transmitting unit 206 may electronically transmit a data single superimposed with the payment credentials and any other data to the consumer device 110, the merchant 110, or payment network 112 for use in processing the payment transaction.

### Exemplary Method for Identifying Payment Credentials Using a Proxy Electronic Wallet

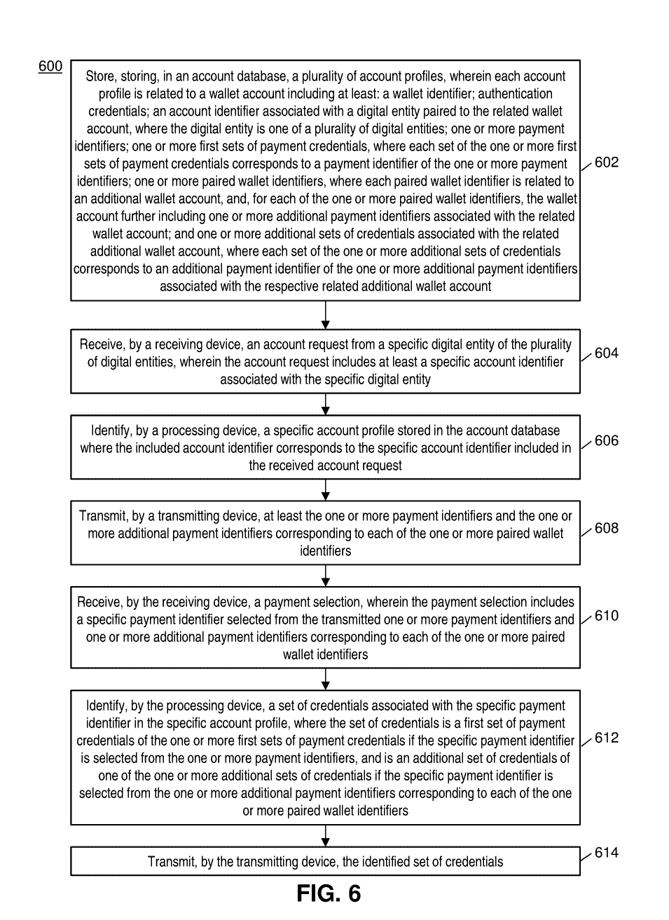

FIG. 6 illustrates a method 600 for the identification of payment credentials for payment accounts stored in a proxy electronic wallet and associated with the proxy electronic wallet, a paired electronic wallet, or a digital entity.

In step 602, a plurality of account profiles (e.g., account profiles 210) may be stored in an account database (e.g., the account database 208), wherein each account profile is related to a wallet account and may include at least: a wallet identifier (e.g., the wallet identifier 302); authentication credentials (e.g., the authentication credentials 304); an account identifier (e.g., the account identifier 306) associated with a digital entity (e.g., the digital entity 106) paired to the related wallet account, where the digital entity is one of a plurality of digital entities; one or more payment identifiers (e.g., payment identifiers 310); one or more first sets of payment credentials (e.g., sets of payment credentials 312), where each set of the one or more first sets of payment credentials corresponds to a payment identifier of the one or more payment identifiers; one or more paired wallet identifiers (e.g., paired wallet identifiers 316), where each paired wallet identifier is related to an additional wallet account, and, for each of the one or more paired wallet identifiers, the wallet account further including one or more additional payment identifiers (e.g., additional payment identifiers 320) associated with the related wallet account; and one or more additional sets of credentials (e.g., sets of credentials 322) associated with the related additional wallet account, where each set of the one or more additional sets of credentials corresponds to an additional payment identifier of the one or more additional payment identifiers associated with the respective related additional wallet account.

In step 604, an account request may be received by a receiving device (e.g., the receiving unit 202) from a specific digital entity of the plurality of digital entities, wherein the account request includes at least a specific account identifier associated with the specific digital entity. In step 606, a specific account profile stored in the account database may be identified by a processing device (e.g., the processing unit 204) where the included account identifier corresponds to the specific account identifier included in the received account request.

In step 608, at least the one or more payment identifiers and the one or more additional payment identifiers correspond to each of the one or more paired wallet identifiers may be transmitted by a transmitting device (e.g., the transmitting unit 206). In step 610, a payment selection may be received by the receiving device, wherein the payment selection includes a specific payment identifier selected from the transmitted one or more payment identifiers and one or more additional payment identifiers corresponding to each of the one or more paired wallet identifiers.

In step 612, a set of credentials associated with the specific payment identifier in the specific account profile may be identified by the processing device, where the set of credentials is a first set of payment credentials of the one or more first sets of payment credentials is the specific payment identifier is selected from the one or more payment identifiers, and is an additional set of credentials of one of the one or more additional sets of credentials if the specific payment identifier is selected from the one or more additional payment identifiers corresponding to each of the one or more paired wallet identifiers. In step 614, the identified set of credentials may be transmitted by the transmitting device.

In some embodiments, the identified set of credentials may be transmitted to the specific digital entity as a response to the received account request. In one embodiment, the identified set of credentials may comprise payment credentials suitable for inclusion in a transaction message associated with a payment transaction for funding of the payment transaction. In some embodiments, the account request may further include supplied authentication credentials, and the method 600 may also include validating, by the processing device, the supplied authentication credentials based on the authentication credentials stored in the specific account profile, wherein the one or more payment identifiers and the one or more additional payment identifiers corresponding to each of the one or more paired wallet identifiers are not transmitted if validation of the supplied authentication credentials is successful.

In one embodiment, each additional set of credentials may comprise account credentials and if the identified set of credentials is an additional set of credentials of one of the one or more additional sets of credentials, the identified set of credentials are transmitted to a third party associated with the wallet account related to the paired wallet identifier corresponding to the additional set of credentials. In a further embodiment, the method 600 may further include receiving, by the receiving device, payment credentials associated with the identified set of credentials from the third party, and transmitting, by the transmitting device, the received payment credentials. In an even further embodiment, the received payment credentials may be transmitted to the specific digital entity as a response to the received account request.

In one embodiment, the method 600 may also include: receiving, by the receiving device, a pairing request from the specific digital entity, wherein the pairing request includes at least the specific account identifier and supplied authentication credentials; and validating, by the processing device, the supplied authentication credentials based on the authentication credentials stored in the specific account profile, wherein the specific account identifier is stored in the specific account profile as the included account identifier if validation of the supplied authentication credentials is successful. In a further embodiment, the method 600 may even further include transmitting, by the transmitting device, a notification to the specific digital entity indicating successful pairing of the specific account identifier with the specific account profile. In another further embodiment, receiving of the pairing request and validating of the supplied authentication credentials may be performed prior to receiving the account request.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 4-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for identifying payment credentials using a proxy electronic wallet. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying payment credentials using a proxy electronic wallet, comprising:
storing, in an account database, a plurality of account profiles, wherein each account profile is related to a wallet account including at least
a wallet identifier,
authentication credentials,
an account identifier associated with a digital entity paired to the related wallet account, where the digital entity is one of a plurality of digital entities,
one or more payment identifiers,
one or more first sets of payment credentials, where each set of the one or more first sets of payment credentials corresponds to a payment identifier of the one or more payment identifiers,
one or more paired wallet identifiers, where each paired wallet identifier is related to an additional wallet account, and, for each of the one or more paired wallet identifiers, the wallet account further including
one or more additional payment identifiers associated with the related wallet account, and
one or more additional sets of credentials associated with the related additional wallet account, where each set of the one or more additional sets of credentials corresponds to an additional payment identifier of the one or more additional payment identifiers associated with the respective related additional wallet account;
receiving, by a receiving device, an account request from a specific digital entity of the plurality of digital entities, wherein the account request includes at least a specific account identifier associated with the specific digital entity;
identifying, by a processing device, a specific account profile stored in the account database where the included account identifier corresponds to the specific account identifier included in the received account request;
transmitting, by a transmitting device, at least the one or more payment identifiers and the one or more additional payment identifiers corresponding to each of the one or more paired wallet identifiers;
receiving, by the receiving device, a payment selection, wherein the payment selection includes a specific payment identifier selected from the transmitted one or more payment identifiers and one or more additional payment identifiers corresponding to each of the one or more paired wallet identifiers;
identifying, by the processing device, a set of credentials associated with the specific payment identifier in the specific account profile, where the set of credentials is a first set of payment credentials of the one or more first sets of payment credentials if the specific payment identifier is selected from the one or more payment identifiers, and is an additional set of credentials of one of the one or more additional sets of credentials if the specific payment identifier is selected from the one or more additional payment identifiers corresponding to each of the one or more paired wallet identifiers; and
transmitting, by the transmitting device, the identified set of credentials.

2. The method of claim 1, wherein the identified set of credentials are transmitted to the specific digital entity as a response to the received account request.

3. The method of claim 1, wherein the identified set of credentials comprise payment credentials suitable for inclusion in a transaction message associated with a payment transaction for funding of the payment transaction.

4. The method of claim 1, wherein
each additional set of credentials comprises account credentials, and
if the identified set of credentials is an additional set of credentials of one of the one or more additional sets of credentials, the identified set of credentials are transmitted to a third party associated with the wallet account related to the paired wallet identifier corresponding to the additional set of credentials.

5. The method of claim 4, further comprising:
receiving, by the receiving device, payment credentials associated with the identified set of credentials from the third party; and
transmitting, by the transmitting device, the received payment credentials.

6. The method of claim 5, wherein the received payment credentials are transmitted to the specific digital entity as a response to the received account request.

7. The method of claim 1, further comprising:
receiving, by the receiving device, a pairing request from the specific digital entity, wherein the pairing request includes at least the specific account identifier and supplied authentication credentials; and
validating, by the processing device, the supplied authentication credentials based on the authentication credentials stored in the specific account profile, wherein
the specific account identifier is stored in the specific account profile as the included account identifier if validation of the supplied authentication credentials is successful.

8. The method of claim 7, further comprising:
transmitting, by the transmitting device, a notification to the specific digital entity indicating successful pairing of the specific account identifier with the specific account profile.

9. The method of claim 7, wherein receiving the pairing request and validating the supplied authentication credentials are performed prior to receiving the account request.

10. The method of claim 1, wherein
the account request further includes supplied authentication credentials, and
the method further comprises:
validating, by the processing device, the supplied authentication credentials based on the authentication credentials stored in the specific account profile, wherein
the one or more payment identifiers and the one or more additional payment identifiers corresponding to each of the one or more paired wallet identifiers are not transmitted if validation of the supplied authentication credentials is unsuccessful.

11. A system for identifying payment credentials using a proxy electronic wallet, comprising:
an account database configured to store a plurality of account profiles, wherein each account profile is related to a wallet account including at least
a wallet identifier,
authentication credentials,
an account identifier associated with a digital entity paired to the related wallet account, where the digital entity is one of a plurality of digital entities,
one or more payment identifiers,
one or more first sets of payment credentials, where each set of the one or more first sets of payment credentials corresponds to a payment identifier of the one or more payment identifiers,
one or more paired wallet identifiers, where each paired wallet identifier is related to an additional wallet account, and, for each of the one or more paired wallet identifiers, the wallet account further including
one or more additional payment identifiers associated with the related wallet account, and
one or more additional sets of credentials associated with the related additional wallet account, where each set of the one or more additional sets of credentials corresponds to an additional payment identifier of the one or more additional payment identifiers associated with the respective related additional wallet account;
a receiving device configured to receive an account request from a specific digital entity of the plurality of digital entities, wherein the account request includes at least a specific account identifier associated with the specific digital entity;
a processing device configured to identify a specific account profile stored in the account database where the included account identifier corresponds to the specific account identifier included in the received account request; and
a transmitting device configured to transmit at least the one or more payment identifiers and the one or more additional payment identifiers corresponding to each of the one or more paired wallet identifiers, wherein
the receiving device is further configured to receive a payment selection, wherein the payment selection includes a specific payment identifier selected from the transmitted one or more payment identifiers and one or more additional payment identifiers corresponding to each of the one or more paired wallet identifiers,
the processing device is further configured to identify a set of credentials associated with the specific payment identifier in the specific account profile, where the set of credentials is a first set of payment credentials of the one or more first sets of payment credentials if the specific payment identifier is selected from the one or more payment identifiers, and is an additional set of credentials of one of the one or more additional sets of credentials if the specific payment identifier is selected from the one or more additional payment identifiers corresponding to each of the one or more paired wallet identifiers, and
the transmitting device is further configured to transmit the identified set of credentials.

12. The system of claim 11, wherein the identified set of credentials are transmitted to the specific digital entity as a response to the received account request.

13. The system of claim 11, wherein the identified set of credentials comprise payment credentials suitable for inclusion in a transaction message associated with a payment transaction for funding of the payment transaction.

14. The system of claim 11, wherein
each additional set of credentials comprises account credentials, and
if the identified set of credentials is an additional set of credentials of one of the one or more additional sets of credentials, the identified set of credentials are transmitted to a third party associated with the wallet account related to the paired wallet identifier corresponding to the additional set of credentials.

15. The system of claim 14, wherein
the receiving device is further configured to receive payment credentials associated with the identified set of credentials from the third party, and
the transmitting device is further configured to transmit the received payment credentials.

16. The system of claim 15, wherein the received payment credentials are transmitted to the specific digital entity as a response to the received account request.

17. The system of claim 11, wherein
the receiving device is further configured to receive a pairing request from the specific digital entity, wherein the pairing request includes at least the specific account identifier and supplied authentication credentials,
the processing device is further configured to validate the supplied authentication credentials based on the authentication credentials stored in the specific account profile, and
the specific account identifier is stored in the specific account profile as the included account identifier if validation of the supplied authentication credentials is successful.

18. The system of claim 17, wherein the transmitting device is further configured to transmit a notification to the specific digital entity indicating successful pairing of the specific account identifier with the specific account profile.

19. The system of claim 17, wherein receiving the pairing request and validating the supplied authentication credentials are performed prior to receiving the account request.

20. The system of claim 11, wherein
the account request further includes supplied authentication credentials, and
the processing device is further configured to validate the supplied authentication credentials based on the authentication credentials stored in the specific account profile, and
the one or more payment identifiers and the one or more additional payment identifiers corresponding to each of the one or more paired wallet identifiers are not transmitted if validation of the supplied authentication credentials is unsuccessful.
